(19) United States
(12) Patent Application Publication
(10) Pub. No.: US 2014/0304115 A1
(43) Pub. Date: Oct. 9, 2014

(54) APPARATUS, SYSTEM, AND METHOD FOR PROVIDING LOCATION CONTEXT DATA

(71) Applicant: PUBLIC ENGINES, INC., Draper, UT (US)

(72) Inventors: William E. Kilmar, Coto de Caza, CA (US); Kyle Kartchner, Bluffdale, UT (US); J. Richard Payne, Santaquin, UT (US)

(73) Assignee: Public Engines, Inc., Draper, UT (US)

(21) Appl. No.: 13/857,809

(22) Filed: Apr. 5, 2013

(51) Int. Cl. G06Q 30/06; G06Q 50/14; G06Q 50/16

(52) U.S. Cl. CPC G06Q 30/0623; G06Q 50/16; G06Q 50/14
USPC 705/26.61

(57) ABSTRACT

An apparatus for providing location context data includes a location identification module, an area selection module, a data module, and a display module. The location identification module identifies one or more geographic locations from a software application. The area selection module selects, for each geographic location, a corresponding geographic area having proximity to the geographic location. The data module retrieves a rating and one or more statistics for each corresponding geographic area. The display module formats, for each identified geographic location, the rating and one or more statistics of the corresponding geographic area for display by the software application.

### FIELD

The subject matter disclosed herein relates to location context data and more particularly relates to providing context data pertaining an identified geographic location.

### BACKGROUND

Individuals unfamiliar with a geographic area can use various software applications to find directions or more information regarding their desired destination. These software applications include, but are not limited to, direction mapping websites, standalone mapping applications, GPS navigation software, travel websites, and real estate websites. These software applications allow users to plan their travel itineraries, peruse real estate properties, and plan other activities at their destination. Whether making travel plans, reviewing homes for sale, or planning other activities at a specific location, it is often desirable to know more about the area, including subjects such as, but not limited to, past or current public safety, school quality, property values, weather, and/or information that may affect the quality and safety of the visit.

### BRIEF SUMMARY

An apparatus for providing location context data includes a location identification module, an area selection module, a data module, and a display module. In one embodiment, the location identification module identifies one or more geographic locations from a software application. In another embodiment, the area selection module selects, for each geographic location, a corresponding geographic area having proximity to the geographic location. In a further embodiment, the data module retrieves data and/or ratings and one or more statistics for each corresponding geographic area. In yet a further embodiment, the display module formats, for each identified geographic location, the rating and one or more statistics of the corresponding geographic area for display by the software application or in conjunction with the software application. In an embodiment, at least a portion of the location identification module, the area selection module, the data module, and the display module include one or more of hardware and executable code, the executable code stored on one or more computer readable storage media.

In one embodiment, the corresponding geographic area is selected from one or more of a city block, a zip code, a local municipality, a county, a metropolitan region, a state, and a country. In another embodiment, the rating retrieved pertains to a subject selected from the group consisting of air quality, education, income, population density, property values, public safety, public transit, school quality, traffic congestion, and weather. In a further embodiment, the one or more statistics pertain to one or more of air quality, education, income, population density, property values, public safety, public transit, school quality, traffic congestion, and weather. In yet another embodiment, the form of a rating includes one or more of a number, a color, a shape, text, and a symbol. In one embodiment, the form of the statistics includes one or more of a number, a color, a shape, a chart, a diagram, a map, text, and a symbol.

In one embodiment, the rating of a corresponding geographic area is based on a comparison of an identical set of one or more statistics for (i) the corresponding geographic area and (ii) one or more other geographic areas. In another embodiment, the rating of a corresponding geographic area is based on a comparison of an identical set of one or more statistics or data for (i) the corresponding geographic area and (ii) one or more other geographic areas, where the corresponding geographic area is adjacent to at least one of the one or more other geographic areas. In yet another embodiment, the rating of a corresponding geographic area is based on a comparison of an identical set of one or more statistics or data for (i) the corresponding geographic area and (ii) one or more other geographic areas, where the corresponding geographic area overlaps with at least one of the one or more other geographic areas. In a further embodiment, the rating of a corresponding geographic area is based on a comparison of an identical set of one or more statistics or data for (i) the corresponding geographic area and (ii) one or more other geographic areas, where the corresponding geographic area is situated within at least one or the one or more other geographic areas.

A method for providing location context data. The method includes identifying one or more geographic locations from a software application. The method includes, for each geographic location, selecting a corresponding geographic area having proximity to the geographic location. The method includes retrieving a rating and one or more statistics for each corresponding geographic area. The method includes, for each geographic location, displaying the rating and one or more statistics of the corresponding geographic area within the software application or in conjunction with the software application.

In another embodiment of the method, the corresponding geographic area is selected from one or more of a city block, a zip code, a local municipality, a county, a metropolitan region, a state, and a country. In yet another embodiment of the method, the rating pertains to a subject selected from the group consisting of air quality, education, income, population density, property values, public safety, public transit, school quality, traffic congestion, and weather. In a further embodiment of the method, the one or more statistics pertains to one or more of air quality, education, income, population density, property values, public safety, public transit, school quality, traffic congestion, and weather. In an embodiment of the method, the form of a rating includes one or more of a number, a color, a shape, text, and a symbol. In another embodiment of the method, the form of the one or more statistics includes one or more of a number, a color, a shape, a chart, a diagram, a map, text, and a symbol.

In one embodiment of the method, a rating of a corresponding geographic area is based on a comparison of an identical set of one or more statistics for (i) the corresponding geographic area and (ii) one or more other geographic areas. In another embodiment of the method, the display of a rating for a corresponding geographic area is asynchronous to the display of the one or more statistics pertaining to the corresponding geographic area.

A computer program product for providing location context data. The computer program product includes a computer readable storage medium having program code embodied therein. In one embodiment, the computer program product identifies one or more geographic locations from a software application. In another embodiment, the computer program product selects, for each geographic location, a corresponding geographic area having proximity to the geographic location. In yet another embodiment, the computer program product retrieves a rating and one or more statistics for each corresponding geographic area. In a further embodiment, the computer program product, for each geographic location, displays the rating and one or more statistics of the corresponding geographic area within the software application or in conjunction with the software application.

A system for providing location context data includes a server and a location context information apparatus. In one embodiment, the location context apparatus includes a location identification module, an area selection module, a data module, and a display module. In one embodiment, the location identification module identifies one or more geographic locations from a software application. In another embodiment, the area selection module selects, for each geographic location, a corresponding geographic area having proximity to the geographic location. In a further embodiment, the data module retrieves a rating and one or more statistics for each corresponding geographic area. In yet a further embodiment, the display module formats, for each identified geographic location, the rating and one or more statistics of the corresponding geographic area for display by the software application or in conjunction with the software application.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for providing location context data;

FIG. 2 is a schematic block diagram illustrating one embodiment of an apparatus for providing location context data;

FIG. 3A is an example of a webpage illustrating the first part of one embodiment of a computer program product for providing location context data;

FIG. 3B is an example of a webpage illustrating the second part of one embodiment of a computer program product for providing location context data;

FIG. 3C is an example of a webpage illustrating the third part of one embodiment of a computer program product for providing location context data;

FIG. 4 is an example of a webpage illustrating another embodiment of a computer program product for providing location context data;

FIG. 5 is a schematic flow chart diagram illustrating one embodiment of a method for providing location context data; and

FIG. 6 is a schematic flow chart diagram illustrating another embodiment of a method for providing location context data.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

The computer program product may be integrated into a client, server and network environment by providing for the computer program product to coexist with applications, operating systems and network operating systems software and then installing the computer program product on the clients and servers in the environment where the computer program product will function.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of preceding figures Like numbers refer to like elements in all figures, including alternate embodiments of like elements.

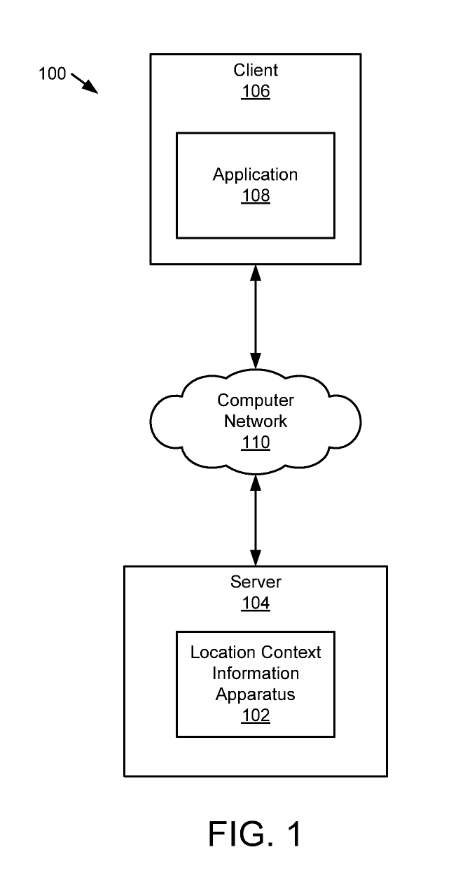

FIG. 1 is a schematic block diagram illustrating one embodiment of a system 100 for providing location context data. The system 100 includes a location context information apparatus 102 on a server 104, a client 106 with a software application 108, and a computer network 110, which are described below.

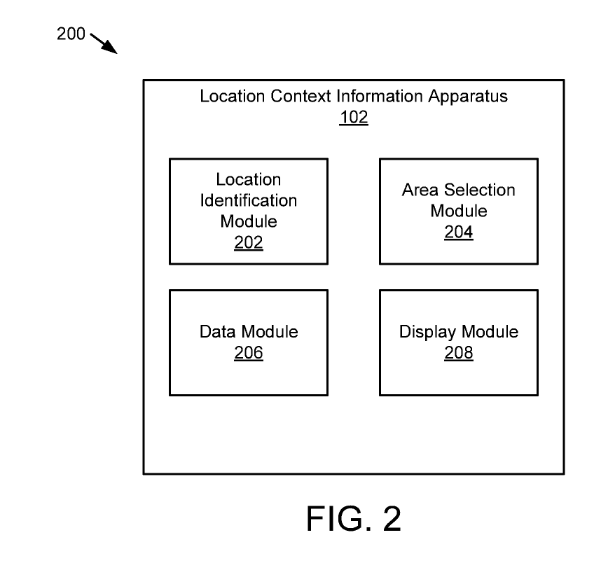

In one embodiment, the system 100 includes a location context information apparatus 102 on a server 104. The location context information apparatus 102 retrieves and formats a rating and one or more statistics pertaining to geographical locations identified from a software application 108. The location context information apparatus 102 is described in more detail with respect to the apparatus 200 of FIG. 2. The server 104 may be a mainframe computer, a blade server, a workstation, a desktop computer, or other computer. The server 104, in one embodiment, includes a plurality of processors, such as a partitioned mainframe with multiple operating system instances. In another embodiment, the server 104 includes one or more subsystems, such as a storage area network. The server 104, may access internal or external storage accessible through a network. The client 106 may be a desktop computer, a laptop, a tablet computer, a smartphone, GPS navigation unit, or other electronic device. The software application 108 on the client 106 may be an operating system, a web browser, or other computer program. The client 106 and server 104 are connected by a computer network 110. The computer network 110 may include a local area network (“LAN”), a wide area network (“WAN”), wireless network, cellular network, the internet, or the like. In this embodiment, information is sent from a software application 108 on a client 106 to the location context information apparatus 102 on the server 104.

In another embodiment, the location context information apparatus 102 resides on both the server 104 and the client 106. In this instance, the location context information apparatus 102 has portions residing on the server 104 and the client 106. The client-side portion of the location context information apparatus 102 may reside within a software application 108 on a client 106, or it may run on a client 106 apart from a software application 108. In one embodiment, information is sent from a software application 108 on a client 106 to the client side portion of the location context information apparatus 102. In an alternative embodiment, the client-side portion of the location context information apparatus 102 residing within a software application 108 identifies geographic locations from the software application 108. A geographic location can include a street, a local municipality, a zip code, a county, a metropolitan region, a state, a country, a landmark, geographic coordinates, or the name of a physical location (e.g., Golden Gate Bridge, Empire State Building).

FIG. 2 is a schematic block diagram illustrating one embodiment of an apparatus 200 for providing location context data. The apparatus 200 includes one embodiment of a location context information apparatus 102 with a location identification module 202, an area selection module 204, a data module 206, and a display module 208, which are described below.

In one embodiment, the location identification module 202 identifies geographic locations from a software application 108 by analyzing information sent from the application 108. The location identification module 202 may analyze information from an application 108 in different ways because the information sent can be in the form of text, a photograph, a map, an audio recording, a video recording, a data structure, or some combination thereof. For example, the location identification module 202 may parse text or audio received from an application 108 for a combination of words and/or numbers that identify a geographic location. In another example, the location identification module 202 parses geographic elements of a map received from an application 108 to identify one or more geographic locations shown on the map.

In another embodiment, the location identification module 202 identifies geographic locations from a software application 108 by analyzing information contained within the application 108. For example, the location identification module 202 may parse the text contained on a browser webpage for a combination of words and/or numbers that identify a geographic location. In another example, the location identification module 202 may query a map object embedded within a browser webpage for the geospatial bounds of the map and the latitude and longitude of its center point to identify a geographical location shown on the map. In a further example, the location identification module 202 may parse the source encoding of a browser webpage for elements that identify a geographic location.

The area selection module 204 selects, for each identified geographic location, a corresponding geographic area having proximity to the geographic location. A geographic area can include a city block, a zip code, a local municipality, a county, a metropolitan region, a state, or a country. In one instance, a geographic location can be situated within a geographic area. In another instance, a geographic location can be adjacent to a geographic area. In yet another instance, a geographic location can overlap with a geographic area. In a certain instance, a geographic location can also be a geographic area. The area selection module 204 may select a geographic area for a geographic location in different ways. In an embodiment, for each geographic location, the area selection module 204 may select the smallest geographic area surrounding a geographic location (e.g., zip code where a street address is located) to correspond to a geographic location. In another embodiment, the corresponding geographic area may be the geographic area nearest a geographic location (e.g., town closest to the Grand Canyon). In one embodiment, the corresponding geographic area may be the geographic location itself. One of skill in the art will recognize other ways to select a geographic area corresponding to a certain geographic location.

The data module 206 retrieves, for each corresponding geographic area, a rating and one or more statistics pertaining to the geographic area. The subject of a rating and statistics for a geographic area may include air quality, education, income, population density, property values, public safety, public transit, school quality, traffic congestion, or weather. In one embodiment, the data module 206 may retrieve a rating and statistics relating to the cost of living in a geographic area. In this embodiment, a rating may indicate the relative affordability of housing in a geographic area (e.g., very affordable, affordable, not affordable) or the relative tax burden on a household (e.g. very high, high, average, low, very low). A statistic may include the median list and sales price of homes sold in the geographic area within the past six months, a list of generally applicable state and local taxes, or other numerical figures relating to cost of living in the selected geographic area. In another embodiment, the data module 206 may retrieve a rating and statistics pertaining to the public safety of a geographic area. In this example, a rating may indicate the relative crime rate of a geographic area with color symbols (e.g., red, yellow, green). A statistic may include the number of violent crimes committed over a six month period within the selected geographic area or the number of registered sex offenders living within the selected geographic area. One of skill in the art will recognize different ratings and statistics that can be retrieved for a geographic area.

The display module 208 formats, for each identified geographic location, the rating and one or more statistics of the corresponding geographic area for display by or in conjunction with the software application 108. The display module 208 may format a rating or statistic in different ways and in varying levels of complexity for the software application 108 to display or to display in conjunction with the software application 108. The form of a rating may include one or more of a number, color, shape, text, or symbol. The form of a statistic may include one or more of a number, color, shape, chart, diagram, map, text, or symbol. In one embodiment, the display module 208 may represent a climate rating for a city with a blue circle to indicate that the average temperature for the city is relatively cool. In another embodiment, the display module 208 may depict the median sales price of homes in a zip code within the past year as a line graph. In a further embodiment, the display module 208 may generate the source code for an example of a webpage that includes a safety rating for crime statistics for a zip code. One of skill in the art will recognize other ways that a rating and statistic may be formatted.

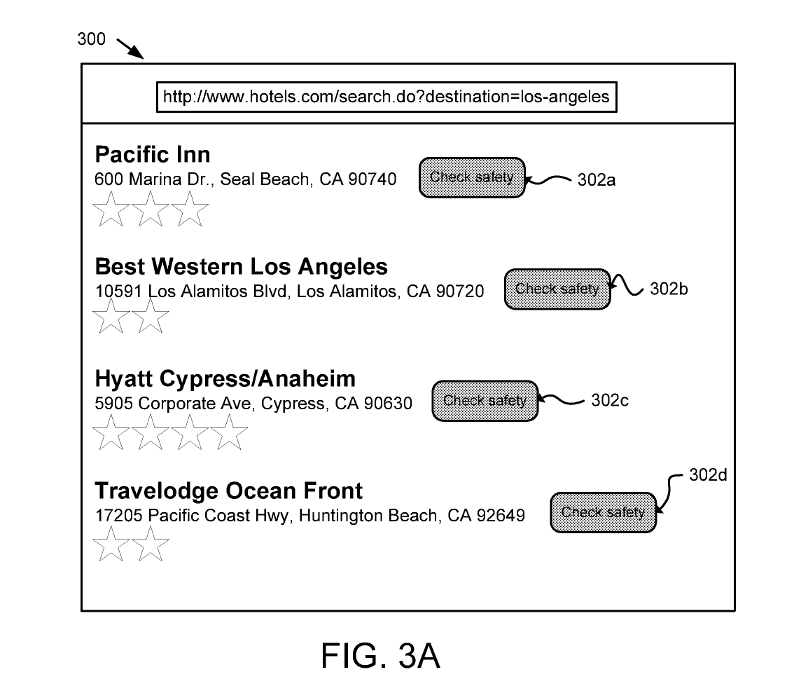

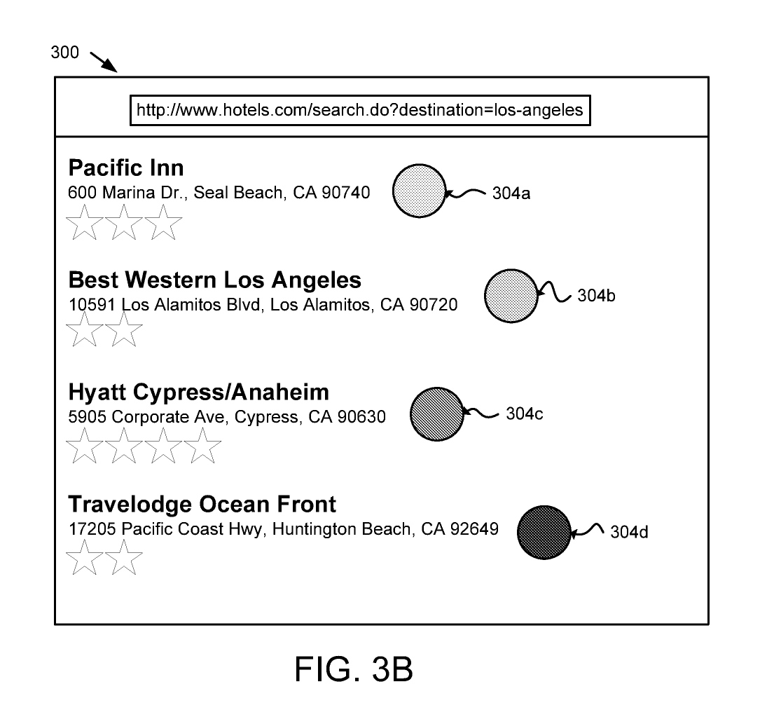

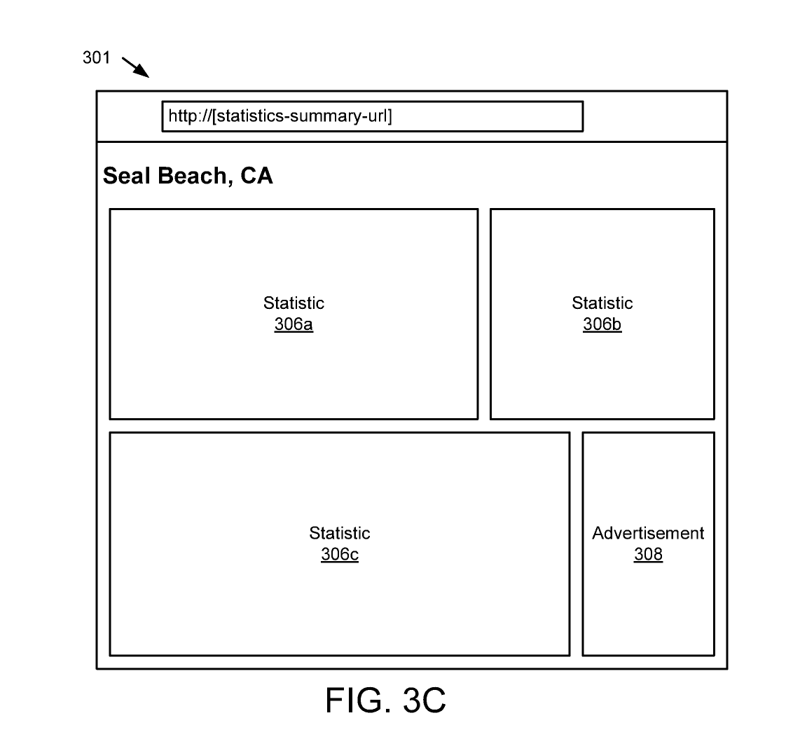

FIGS. 3A, 3B, and 3C are examples of webpages illustrating a first part, a second part, and a third part of one embodiment of a computer program product for providing location context data. In FIG. 3A, the example webpage 300 shows a number of hotels located across the Los Angeles metropolitan region and includes multiple instances of a mechanism 302a, 302b, 302c, 302d (collectively “302”) for displaying a local safety rating 304 for each hotel as identified by the hotel's address. In this example webpage 300, the mechanism 302 is a button icon embedded within the webpage. The mechanism 302 is not limited to being an icon and may take other forms. In this embodiment, when a user activates a mechanism 302, the computer program searches the source encoding of the webpage to identify geographic locations (e.g., hotel addresses) within the webpage. In this embodiment, the computer program may include executable code that is (i) embedded within the webpage or (ii) part of a browser plugin. The executable code can be written in a variety of programming languages, including but not limited to, javascript, perl, C, or C++. Once the computer program identifies geographic locations within a webpage, it identifies a corresponding geographic area for each location. In one embodiment, the computer program may identify the zip code that a hotel is located within as the corresponding geographic area. In another embodiment, the computer program may identify the city that a hotel is located within as the corresponding geographic area. Once a corresponding geographic area has been identified, the computer program retrieves a local safety rating 304 for each geographic area and one or more statistics related to the safety rating.

In FIG. 3B, the example webpage 300 displays the public safety ratings 304a, 304b, 304c, 304d (collectively, “304”) of the hotels' locations as color-filled circles. The circles may be an overlay on top of the webpage 300. In this embodiment, the color of the circle indicates the relative safety of a hotel's geographic location. For example, a red circle may indicate that a geographic area is relatively unsafe, while a green circle indicates that the area is relatively safe. In an embodiment, when a mouse pointer hovers over a rating, a pop-up (not shown) may appear showing an explanation for the rating. In another embodiment, a pop-up may show one or more statistics related to a rating. In a certain embodiment, the pop-up may include a hyperlink to a webpage showing one or more statistics related to the rating.

In FIG. 3C, the example webpage 301 displays statistics 306a, 306b, and 306c (collectively, “306”) related to local safety rating 304a. The statistics 306 may include numbers, charts, graphs, diagrams, tables, or the like. In one embodiment, in addition to the statistics 306, the example webpage 301 may also include one or more advertisements 308 for a business in the selected geographic area. In another embodiment, the advertisement 308 may promote a business in a nearby geographic area.

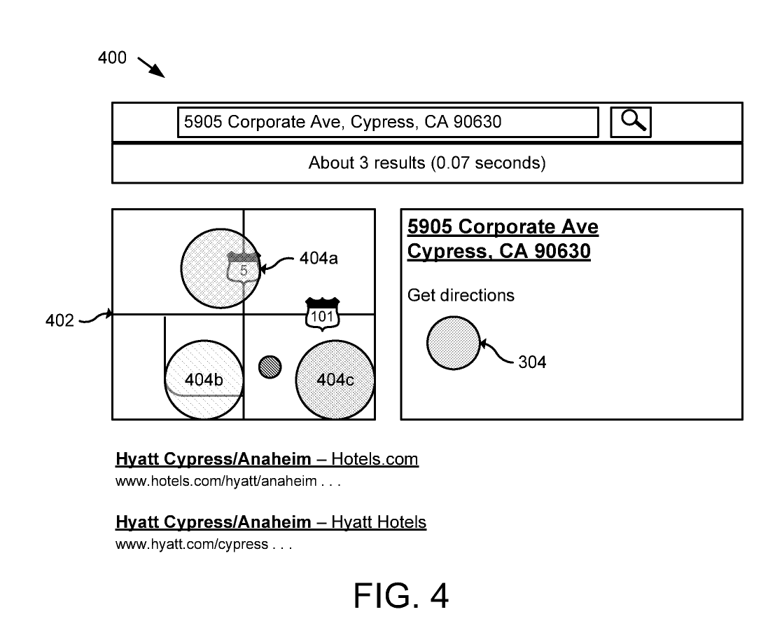

FIG. 4 is an example of a webpage illustrating another embodiment of a computer program product for providing location context data. In FIG. 4, the example webpage 400 shows search results for an address and includes an embedded map 402 showing the given address. In this example, the computer program product for providing location context data automatically retrieves and displays a local safety rating 304 for the given address without a user prompt. In addition, the computer program also displays crime statistics 404a, 404b, and 404c (collectively, “404”) for geographic areas near the given address. In one embodiment, the crime statistics 404 may be depicted as shaded regions (e.g., heat density maps), with shade intensity indicating different crime rates. The shaded regions depicting the crime statistics 404 may be overlaid on top of the webpage 400 by the computer program product. In another embodiment, the crime statistics 404 may be depicted as numbers showing the number of crimes reported to police during a certain period of time. One of skill in the art will recognize different ways that crime statistics 404 may be depicted.

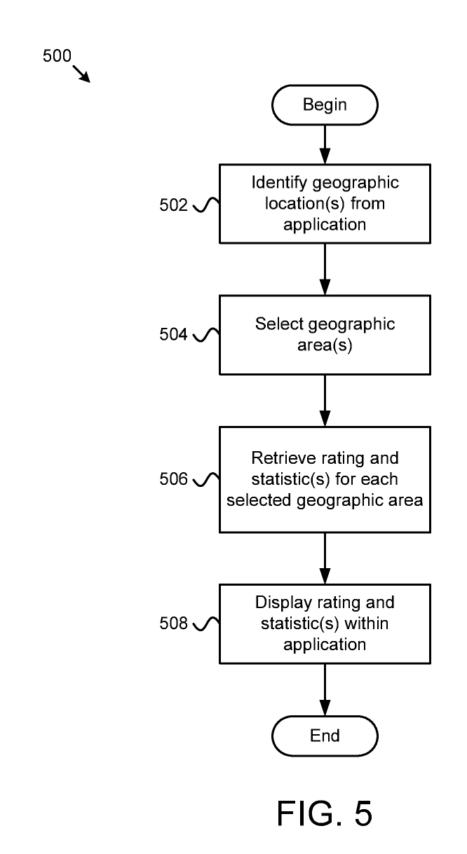

FIG. 5 is a schematic flow chart diagram illustrating one embodiment of a method 500 for providing location context data. The method 500 begins and in one embodiment, the location identification module 202 identifies 502 one or more geographic locations from a software application 108. The method 500 selects 504 a geographic area corresponding to each geographic location. In one embodiment, the area selection module 204 selects 504, for each identified geographic location, a corresponding geographic area having proximity to the geographic location.

The method 500 retrieves 506 a rating and one or more statistics for each geographic area. In one embodiment, the data module 206 retrieves 506, for each corresponding geographic area, a rating and one or more statistics. The method 500 displays 508 the rating and statistic(s) within or in conjunction with the software application 108 and the method 500 ends. In one embodiment, the display module 208 displays 508, for each identified geographic location, the rating and statistic(s) for the corresponding geographic area within or in conjunction with the software application 108.

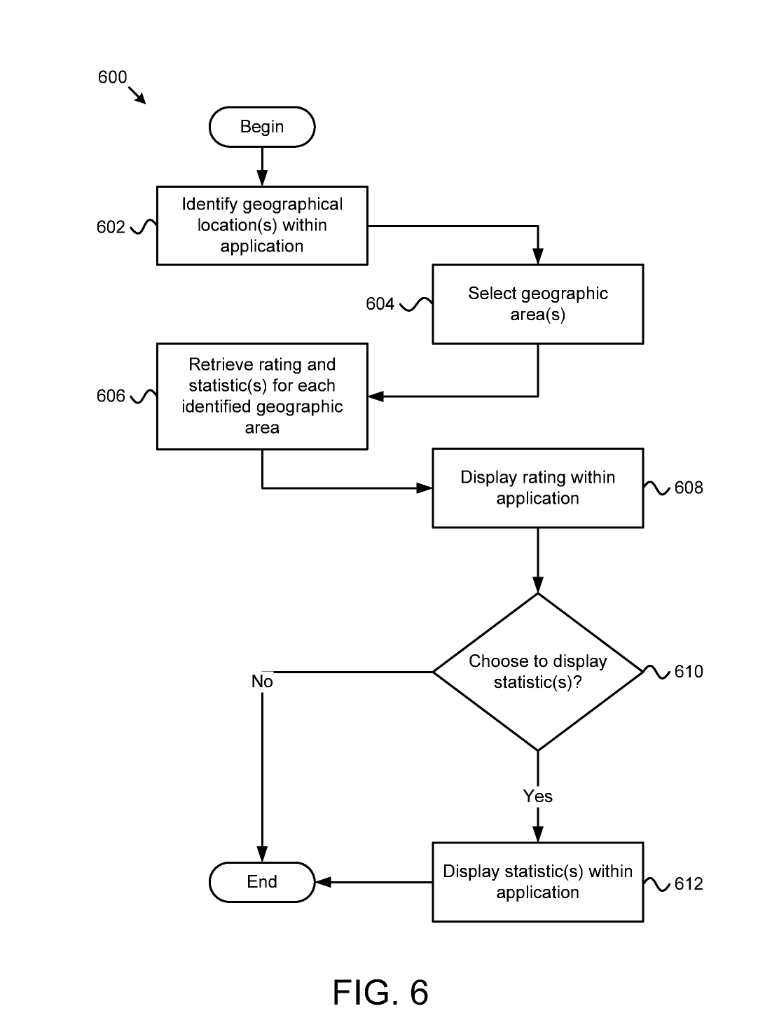

FIG. 6 is a schematic flow chart diagram illustrating another embodiment of a method 600 for providing location context data. The method 600 begins and in one embodiment, the location identification module 202 identifies 602 one or more geographic locations from a software application 108. The method 600 selects 604 a geographic area corresponding to each geographic location. In one embodiment, the area selection module 204 selects 604, for each identified geographic location, a corresponding geographic area having proximity to the geographic location.

The method 600 retrieves 606 a rating and one or more statistics for each geographic area. In one embodiment, the data module 206 retrieves 606, for each corresponding geographic area, a rating and one or more statistics. The method 600 displays 608 the rating within or in conjunction with the software application 108. In one embodiment, the display module 208 displays 608, for each identified geographic location, the rating for the corresponding geographic area within or in conjunction with the software application 108. The method 600 chooses 610 whether to display one or more statistics. In one embodiment, a user chooses 610 to display, for each identified geographic location, one or more statistics for the corresponding geographic area within or in conjunction with the software application 108. The method 600 displays 612 one or more statistics within or in conjunction with the software application 108 and method 600 ends. In one embodiment, the display module 208 displays 612, for a geographic location, one or more statistics of the corresponding geographic area within or in conjunction with the software application 108 and method 600 ends. In another embodiment, a user chooses 610 not to display any statistics and the method 600 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a location identification module that identifies one or more geographic locations from a software application;
an area selection module that, for each geographic location, selects a corresponding geographic area having a proximity to the geographic location;
a data module that retrieves a rating and one or more statistics or data for each corresponding geographic area;
a display module that, for each geographic location, formats the rating and one or more statistics of the corresponding geographic area for display by or in conjunction with the software application;
wherein at least a portion of the location identification module, the area selection module, the data module, and the display module comprise one or more of hardware and executable code, the executable code stored on one or more computer readable storage media.

2. The apparatus of claim 1, wherein the corresponding geographic area is selected from one or more of a city block, a zip code, a local municipality, a county, a metropolitan region, a state, and a country.

3. The apparatus of claim 1, wherein the rating pertains to a subject selected from the group consisting of air quality, education, income, population density, property values, public safety, public transit, school quality, traffic congestion, and weather.

4. The apparatus of claim 1, wherein the one or more statistics pertains to one or more of air quality, education, income, population density, property values, public safety, public transit, school quality, traffic congestion, and weather.

5. The apparatus of claim 1, wherein the form of a rating comprises one or more of a number, color, shape, text, and symbol.

6. The apparatus of claim 1, wherein the form of the one or more statistics comprises one or more of a number, color, shape, chart, diagram, map, text, and symbol.

7. The apparatus of claim 1, wherein a rating of a corresponding geographic area is based on a comparison of an identical set of one or more statistics for (i) the corresponding geographic area and (ii) one or more other geographic areas.

8. The apparatus of claim 6, wherein the corresponding geographic area is adjacent to at least one of the one or more other geographic areas.

9. The apparatus of claim 6, wherein the corresponding geographic area overlaps with at least one of the one or more other geographic areas.

10. The apparatus of claim 6, wherein the corresponding geographic area is situated within at least one of the one or more other geographic areas.

11. A method comprising:
identifying one or more geographic locations from a software application;
for each geographic location, selecting a corresponding geographic area having proximity to the geographic location;
retrieving a rating and one or more statistics for each corresponding geographic area; and
for each geographic location, displaying the rating and one or more statistics of the corresponding geographic area within or in conjunction with the software application.

12. The method of claim 11, wherein the corresponding geographic area is selected from one or more of a city block, a zip code, a local municipality, a county, a metropolitan region, a state, and a country.

13. The method of claim 11, wherein the rating pertains to a subject selected from the group consisting of air quality, education, income, population density, property values, public safety, public transit, school quality, traffic congestion, and weather.

14. The method of claim 11, wherein the one or more statistics pertains to one or more of air quality, education, income, population density, property values, public safety, public transit, school quality, traffic congestion, and weather.

15. The method of claim 11, wherein the form of a rating comprises one or more of a number, color, shape, text, and symbol.

16. The method of claim 11, wherein the form of the one or more statistics comprises one or more of a number, color, shape, chart, diagram, map, text, and symbol.

17. The method of claim 11, wherein a rating of a corresponding geographic area is based on a comparison of an identical set of one or more statistics for (i) the corresponding geographic area and (ii) one or more other geographic areas.

18. The method of claim 11, wherein the display of a rating for a corresponding geographic area is asynchronous to the display of the one or more statistics pertaining to the corresponding geographic area.

19. A computer program product for providing location context data, the computer program product comprising a computer readable storage medium having program code embodied therein, the program code readable/executable by a process to:
identify one or more geographic locations from a software application;
for each geographic location, select a corresponding geographic area having proximity to the geographic location;
retrieve a rating and one or more statistics for each corresponding geographic area;
for each geographic location, display the rating and one or more statistics of the corresponding geographic area within or in conjunction with the software application.

20. A system comprising:
a server; and
a location context information apparatus executing at least partially on the server, the location context information apparatus comprising:
a location identification module that identifies one or more geographic locations from a software application;
an area selection module that, for each geographic location, selects a corresponding geographic area having proximity to the geographic location;
a data module that retrieves a rating and one or more statistics for each corresponding geographic area;
a display module that, for each geographic location, formats the rating and one or more statistics of the corresponding geographic area for display by or in conjunction with the software application.
